(19) United States
(12) Patent Application Publication
(10) Pub. No.: US 2011/0153431 A1
(43) Pub. Date: Jun. 23, 2011

(54) APPARATUS AND METHOD FOR TARGETED ADVERTISING BASED ON IMAGE OF PASSERBY

(75) Inventors: Hye Mi KIM, Daejeon (KR); Jae Hean KIM, Yongin-si (KR); Il Kwon JEONG, Daejeon (KR); Jin Ho KIM, Daejeon (KR); Myung Gyu KIM, Daejeon (KR); Sang Won GHYME, Daejeon (KR); Sung June CHANG, Daejeon (KR); Man Kyu SUNG, Daejeon (KR); Brian AHN, Seoul (KR); Byoung Tae CHOI, Daejeon (KR); Young Jik LEE, Daejeon (KR)

(73) Assignee: Electronics and Telecommunications Research Institute, Daejeon (KR)

(21) Appl. No.: 12/825,892

(22) Filed: Jun. 29, 2010

(30) Foreign Application Priority Data
Dec. 21, 2009 (KR) 10-2009-0127724

(51) Int. Cl. G06Q 30/00; G06K 9/46

(52) U.S. Cl. 705/14.66; 382/195

(57) ABSTRACT

Provided is an apparatus for targeted advertising based on images of passersby. A passerby image extraction unit extracts an image of a passerby. A trait information extraction unit extracts trait information regarding the passerby from the extracted image. A targeted advertisement obtainment unit obtains a targeted advertisement to be displayed based on the trait information. A targeted advertisement display unit displays the targeted advertisement.

### CROSS-REFERENCE TO RELATED APPLICATIONS

This application claims priority under 35 U.S.C. §119 to Korean Patent Application No. 10-2009-0127724, filed on Dec. 21, 2009, in the Korean Intellectual Property Office, the disclosure of which is incorporated herein by reference in its entirety.

### TECHNICAL FIELD

The following disclosure relates to an apparatus and a method for targeted advertising based on images of passersby, and in particular, to an apparatus and a method for catching the trait and tendency of a passerby based on his/her image and providing an advertisement targeted to the passerby.

### BACKGROUND

Targeted advertising is expected to be the most decisive sector in the future advertising market. Specifically, the market of advertising targeted to a specific audience based on their manner of watching and consuming is becoming bigger every year, and the US market is expected to amount to about $2.5 billion in 2010 and about $3.8 billion in 2011.

A well-known example of online targeted advertising is AdSense of Google Inc. AdSense is an online advertising platform developed by Google Inc. Specifically, it analyzes contents of homepages, blogs, etc. and provides advertisements considered suitable based on the result of analysis. This approach is based on the recognition that visitors interested in a specific homepage or blog are likely to click targeted advertisements appearing on that site, and is thought highly of in the market.

Another example is Qook Smartweb service commercialized by KT Corp., Korea. According to this approach, a cookie is recorded on the PC of a user, and his/her interests are deduced from the cookie to provide advertisements targeted to the user. In other words, this type of targeted advertising is based on information regarding how people use the Internet.

However, there is concern about privacy infringement by such an approach in the process of analyzing and tracing particulars of Internet surfing by users to provide targeted advertisements.

Targeted advertisements are also provided offline.

For example, a system for outdoor targeted advertising catches the interests and traits of passersby based on information regarding their belongings, etc. within a short period of time. The system then provides advertisements supposed to interest them.

More specifically, advertisements supposed to interest a passerby are selected in the following manner.

The system for outdoor targeted advertising identifies the belongings of a passerby by wireless automatic recognition technology and uses the result of recognition as basic data, which is analyzed to obtain information. Then, the system selects advertisements of products or services that are expected to interest the passerby based on the information, and the system delivers the selected advertisement to the passerby.

Exemplary wireless automatic recognition technologies employable by the system for outdoor targeted advertising include RFID, Bluetooth, etc.

The RFID technology is employed as follows: RFID tags are attached to belongings of a target audience, and RFID readers, with which the system for outdoor targeted advertising is equipped, read information recorded on the RFID tags to detect the belongings.

The Bluetooth technology may also be similarly used to obtain information regarding the belongings of a target audience.

However, such a system for outdoor targeted advertising in the related art has problem with that it can be used only when wireless automatic recognition technology has been applied to the belongings of the audience.

### SUMMARY

In one general aspect, an apparatus for targeted advertising based on images of passersby includes: a passerby image extraction unit extracting an image of a passerby; a trait information extraction unit extracting trait information regarding the passerby from the extracted image; a targeted advertisement obtainment unit obtaining a targeted advertisement to be displayed based on the trait information; and a targeted advertisement display unit displaying the targeted advertisement.

The apparatus may further include a circumstance image extraction unit extracting a real-time circumstance image containing the image of the passerby near the apparatus, and the passerby image extraction unit may extract the image of the passerby from the real-time circumstance image.

The circumstance image extraction unit may be attached to the apparatus.

The trait information extraction unit may extract the trait information including at least one of gender information, age information, facial expression information, and belongings information regarding the passerby.

The trait information extraction unit may include: a preprocessor extracting an area of interest from the extracted image and aligning the area of interest; a feature information extractor extracting feature information from the area of interest; and a feature classifier comparing the feature information with predetermined reference information and extracting the trait information.

The trait information extraction unit may extract the trait information from the area of interest by employing a feature extraction method widely used in the field of pattern recognition, such as Principal Component Analysis (PCA), Linear Discriminant Analysis (LDA), and Gabor Wavelet (GW).

The trait information extraction unit may extract the trait information by employing a feature classification method widely used in the field of pattern recognition, such as Radial Basis Function (RBF) and Support Vector Machine (SVM).

The predetermined reference information may be created with reference to at least one of gender, age, facial expressions, and belongings and stored, and the information extraction unit may extract at least one of gender information, age information, facial expression information, and belongings information regarding the passerby based on the predetermined reference information.

The preprocessor may extract the area of interest containing at least one of a facial area and a belongings area of the passerby.

The targeted advertisement obtainment unit may select the targeted advertisement from at least one kind of pre-stored advertising contents based on the trait information and a predetermined selection criterion.

The predetermined selection criterion may include at least one of information regarding consumption patterns based on gender and information regarding advertising requirements of advertisers.

The targeted advertisement obtainment unit may obtain the targeted advertisement containing an avatar, which looks like the passerby, created based on the trait information.

The targeted advertisement obtainment unit may obtain the targeted advertisement inserting the avatar into the image obtained by the circumstance image extraction unit.

In another general aspect, a method for providing an advertisement display device with targeted advertisements based on images of passersby includes: extracting an image of a passerby; extracting trait information regarding the passerby from the extracted image; obtaining a targeted advertisement to be displayed based on the trait information; and displaying the targeted advertisement.

The method may further include extracting a real-time circumstance image containing the image of the passerby near the advertisement display device before the extracting an image of a passerby, and the extracting an image of a passerby may include extracting the image of the passerby from the real-time circumstance image.

The extracting of the trait information may include extracting the trait information including at least one of gender information, age information, facial expression information, and belongings information regarding the passerby.

The extracting of the trait information may include: extracting an area of interest from the extracted image and aligning the area of interest; extracting feature information from the area of interest; and comparing the feature information with the predetermined reference information and extracting the trait information.

The extracting of the feature information may include extracting the trait information from the area of interest by employing a feature extraction method widely used in the field of pattern recognition, such as Principal Component Analysis (PCA), Linear Discriminant Analysis (LDA), and Gabor Wavelet (GW).

The comparing of the feature information with the predetermined to reference information may include extracting the trait information by employing a feature extraction method widely used in the field of pattern recognition, such as Radial Basis Function (RBF) and Support Vector Machine (SVM).

The predetermined reference information may be created with reference to at least one of gender, age, facial expressions, and belongings and stored, and the comparing the feature information with the predetermined reference information may include extracting the trait information including at least one of gender information, age information, facial expression information, and belongings information regarding the passerby based on the predetermined reference information.

The extracting of the area of interest may include extracting the area of interest containing at least one of a facial area and a belongings area of the passerby.

The obtaining of the targeted advertisement may include selecting the targeted advertisement from at least one kind of pre-stored advertising contents based on the trait information and a predetermined selection criterion.

The predetermined selection criterion may include at least one of information regarding consumption patterns based on gender and information regarding advertising requirements of advertisers.

The obtaining of the targeted advertisement may include obtaining the targeted advertisement containing an avatar created based on the trait information.

The obtaining of the targeted advertisement may include obtaining the targeted advertisement by selecting advertising contents from at least one kind of pre-stored advertising contents based on the trait information and a pre-determined criterion and inserting the avatar into the selected advertising contents.

In another general aspect, a computer-readable recording medium storing a program for realizing each operation of the above-mentioned method for targeted advertising based on images of passersby is provided.

Other features and aspects will be apparent from the following detailed description, the drawings, and the claims.

### BRIEF DESCRIPTION OF THE DRAWINGS

FIG. 1 is a block diagram of an apparatus for targeted advertising based on images of passersby according to an exemplary embodiment.

FIG. 2 is a block diagram of a trait information extraction unit of an apparatus for targeted advertising based on images of passersby according to an exemplary embodiment.

FIG. 3 is a flowchart of a method for targeted advertising based on images of passersby according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

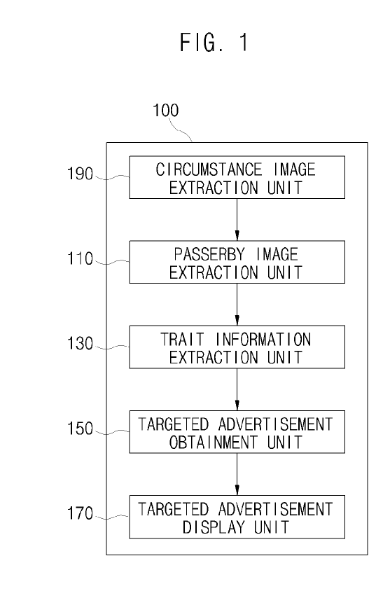

FIG. 1 is a block diagram of an apparatus for targeted advertising based on images of passersby according to an exemplary embodiment.

Referring to FIG. 1, an apparatus 100 for targeted advertising based on images of passersby according to an exemplary embodiment includes a passerby image extraction unit 110, a trait information extraction unit 130, a targeted advertisement obtainment unit 150, and a targeted advertisement display unit 170. Referring to FIG. 1 again, the apparatus 100 may further include a circumstance image extraction unit 190.

The passerby image extraction unit 110 is configured to extract images of passersby near the apparatus 100.

The apparatus 100 may be equipped with a circumstance image extraction unit 190.

The circumstance image extraction unit 190 is configured to extract real-time circumstance images, including images of passersby near the apparatus 100. Specifically, the circumstance image extraction unit 190 may be an imaging device (e.g. camera) attached to the apparatus 100, which may be implemented as an outdoor advertising structure (e.g. billboard), to obtain real-time images of circumstance images, including images of passersby (i.e. target audience) near the apparatus 100.

The passerby image extraction unit 110 is configured to extract images of passersby from the real-time circumstance images and to provide the extracted images for later trait information extraction, etc. The passerby image extraction unit 110 may employ pedestrian recognition technology or face extraction technology, which is commonly used in the field of computer vision, to extract images of passersby from the real-time circumstance images.

For example, the passerby image extraction unit 110 may extract passerby images by using the Haar-based approach, which is combined with the polynomial support vector machine as proposed by Papageorgiou and Poggio. The passerby image extraction unit 110 may also employ the approach proposed by Gavrila and Philomin, which utilizes the chamfer distance between an edge image and a template database, or the approach proposed by Viola, which is based on an extended set of Haar-like features.

However, it is to be noted that the above-mentioned examples of technology employable by the passerby image extraction unit 110 are for illustrative purposes only, and are not intended to be limiting in any manner.

The trait information extraction unit 130 is configured to extract information regarding the traits of passersby from images extracted by the passerby image extraction unit 110.

The trait information may include, for example, at least one of gender information, age information, facial expression information, and belongings information related to passersby.

The trait information serves as basic information from which contents targeted to passersby (i.e. targeted advertisements) are provided later. To this end, information regarding traits of passersby that are considered useful in recognizing their tendencies is obtained by analyzing images of passersby.

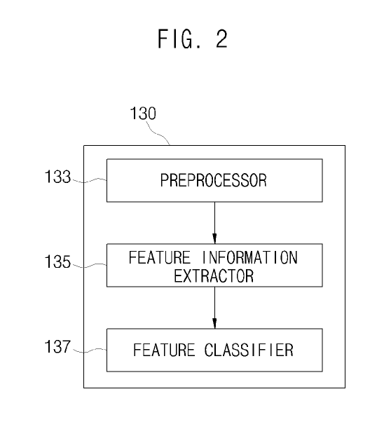

The trait information extraction unit will now be described in more detail with reference to FIG. 2.

FIG. 2 is a block diagram of a trait information extraction unit of an apparatus for targeted advertising based on images of passersby according to an exemplary embodiment.

Referring to FIG. 2, the trait information extraction unit 130 includes a preprocessor 133, a feature information extractor 135, and a feature classifier 137.

The preprocessor 133 is configured to extract areas of interest from passerby images, which have been extracted by the passerby image extraction unit 110, and align the areas of interest.

As used herein, the areas of interest refer to specific areas of passerby images from which features of passersby can be extracted more easily, and include at least one of the facial area of passersby and the area of their belongings.

The feature information extractor 135 is configured to extract feature information from the areas of interest extracted by the preprocessor 133.

For example, the feature information extractor 135 extracts feature information from the areas of interest by employing at least one technique selected from Principal Component Analysis (PCA), Linear Discriminant Analysis (LDA), and Gabor Wavelet (GW), all of which apply feature dimension reduction algorithms to extract feature information in vector type.

The feature classifier 137 is configured to compare feature information, which has been extracted by the feature information extractor 135, with the predetermined reference information to extract trait information.

For example, the feature classifier 137 extracts trait information by employing a feature extraction method commonly used in the field of pattern recognition, such as Radial Basis Function (RBF), Support Vector Machine (SVM), etc.

For example, feature information extracted in vector type is compared with the predetermined reference information to extract trait information.

As mentioned above, the trait information may include at least one of gender information, age information, facial expression information, and belongings information related to passersby.

Therefore, the predetermined reference information may be created in advance with reference to at least one of the gender, age, facial expressions, and belongings of passersby and stored in vector type for comparison with the feature information.

For example, the predetermined reference information may include gender information to distinguish between male and female passersby.

The predetermined reference information may also include age information, which is obtained by pre-learning of different ages of people, for easy extraction of features related to age.

The predetermined reference information may also include facial expression information, which is obtained by pre-learning of facial expressions corresponding to various human emotions, for easy extraction of features related to facial expressions.

As mentioned above, the trait information classified by the feature classifier 137 may include information regarding the belongings worn or carried by passersby, such as hats, handbags, laptop bags, suitcases, etc.

To this end, the predetermined reference information may include belongings information, which is obtained by pre-learning of different types of belongings, for easy extraction of features related to specific belongings.

The targeted advertisement obtainment unit 150 is configured to obtain targeted advertisements, which are to be displayed by the targeted advertisement display unit 170, based on the trait information extracted by the trait information extraction unit 130.

Specifically, the targeted advertisement obtainment unit 150 obtains contents supposed to interests passersby (i.e. target audience) based on at least one of their gender, age, facial expressions, and belongings.

For example, the targeted advertisement obtainment unit 150 selects from at least one kind of pre-stored advertising contents based on the trait information extracted by the trait information extraction unit 130, as well as on predetermined selection criteria.

The predetermined selection criteria may include at least one of information regarding consumption patterns based on gender and information regarding advertising requirements of advertisers.

Meanwhile, in order to interest passersby to a larger extent, the targeted advertisement obtainment unit 150 may obtain targeted advertisements containing avatars created by using the trait information extracted by the trait information extraction unit 130.

For example, the targeted advertisement obtainment unit 150 recognizes the age, gender, facial expressions, clothes, and other external traits of a passerby from his/her images and create a similar-looking avatar, which is displayed in real time to interest the passerby.

The targeted advertisement obtainment unit 150 may also obtain targeted advertisements, which have been selected from at least one kind of pre-stored advertising contents based on trait information and predetermined selection criteria, and into which the above-mentioned avatars created based on passerby trait information have been inserted.

The targeted advertisement display unit 170 is configured to display targeted advertisements obtained by the targeted advertisement obtainment unit 150. The targeted advertisement display unit 170 may be implemented as any device capable of displaying moving pictures, such as a LCD, a PDP TV, a billboard, a projector, etc.

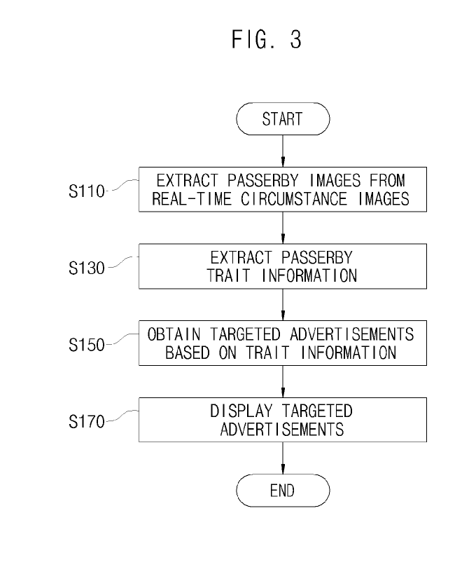

FIG. 3 is a flowchart of a method for targeted advertising based on images of passersby according to an exemplary embodiment. The method is directed to providing an advertisement display device (e.g. billboard) with advertisements selected based on images of passersby.

Therefore, the method for targeted advertising based on images of passersby according to an exemplary embodiment may be realized inside an advertisement display device (e.g. billboard). Alternatively, the method may be realized by a control device connected via a network to control the advertisement display device.

Referring to FIG. 3, images of passerby are extracted in operation S110.

Specifically, real-time circumstance images are extracted, which include images of passersby near the advertisement display device, and the real-time circumstance images are then inputted to extract images of passersby.

In subsequent operation S130, information regarding traits of passersby is extracted from the images, which have been extracted in operation S110. The trait information may include at least one of gender information, age information, facial expression information, and belongings information related to passersby.

Areas of interests are extracted from the images, which have been extracted in operation S110, and are aligned to extract trait information. The areas of interest refer to specific areas of passerby images from which features of passersby can be extracted more easily, and include at least one of the facial area of passersby and the area of their belongings.

Feature information is then extracted from the areas of interest.

For example, feature information is extracted from the areas of interest by employing at least one technique selected from Principal Component Analysis (PCA), Linear Discriminant Analysis (LDA), and Gabor Wavelet (GW), all of which apply feature dimension reduction algorithms to extract feature information in vector type.

The extracted feature information is then compared with the predetermined reference information to extract trait information.

The trait information may be extracted by employing, for example, at least one technique selected from Radial Basis Function (RBF) and Support Vector Machine (SVM).

For example, feature information extracted in vector type is compared with the predetermined reference information to extract trait information.

As mentioned above, the trait information may include, for example, at least one of gender information, age information, facial expression information, and belongings information related to passersby.

Therefore, the predetermined reference information may be created in advance with regard to at least one of the gender, age, facial expressions, and belongings of passersby and stored in vector type for comparison with the feature information.

For example, the predetermined reference information may include gender information to distinguish between male and female passersby.

The predetermined reference information may also include age information, which is obtained by pre-learning of different ages of people, for easy extraction of features related to age.

The predetermined reference information may also include facial expression information, which is obtained by pre-learning of facial expressions corresponding to various human emotions, for easy extraction of features related to facial expressions.

The predetermined reference information may also include belongings information, which is obtained by pre-learning of different types of belongings, for easy extraction of features related to specific belongings.

In subsequent operation S150, targeted advertisements to be displayed by the advertisement display device are extracted from the trait information extracted in operation S130.

Specifically, contents supposed to interests passersby (i.e. target audience) are obtained based on at least one of their gender, age, facial expressions, and belongings.

For example, targeted advertisements are selected from at least one kind of pre-stored advertising contents based on the trait information, as well as on predetermined selection criteria, in operation S150.

The predetermined selection criteria may include at least one of information regarding consumption patterns based on gender and information regarding advertising requirements of advertisers.

Meanwhile, in order to interest passersby to a larger extent, the targeted advertisements obtained in operation S150 may include avatars created by using the trait information.

For example, the age, gender, facial expressions, clothes, and other external traits of a passerby are recognized from his/her images, and a similar-looking avatar is created, which is displayed in real time to interest the passerby.

It is also possible in operation S150 to obtain targeted advertisements by selecting advertising contents from at least one kind of pre-stored advertising contents based on trait information and pre-determined criteria and inserting the avatars, which have been created based on passerby trait information, into the selected advertising contents.

In subsequent operation S170, the targeted advertisements obtained in operation S150 are displayed.

The targeted advertisements may be displayed by any device capable of displaying moving pictures, such as a LCD, a PDP TV, a billboard, a projector, etc.

As such, according to an exemplary embodiment, passerby trait information is extracted from images of passersby, even if they do not carry goods to which wireless automatic recognition technology has been applied. Then, to advertising contents considered suitable to the passersby are selected and provided.

This minimizes objection to unilateral delivery of advertising information, which hardly interests passersby as in the case of other outdoor advertising structures.

It is also possible to provide advertisements expected to help or highly interest passersby based on passerby trait information. Passersby may also be provided with real-time contents supposed to interest them.

The invention can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet). The computer-readable storage medium can also be distributed over network coupled computer systems so that the computer readable codes are stored and executed in a distributed fashion. Also, functional programs, codes, and code segments for accomplishing the present invention can be easily construed by programmers skilled in the art to which the present invention pertains.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for targeted advertising based on images of passersby, comprising:
a passerby image extraction unit extracting an image of a passerby;
a trait information extraction unit extracting trait information regarding the passerby from the extracted image;
a targeted advertisement obtainment unit obtaining a targeted advertisement to be displayed based on the trait information; and
a targeted advertisement display unit displaying the targeted advertisement.

2. The apparatus of claim 1, wherein the apparatus further comprises a circumstance image extraction unit extracting a real-time circumstance image containing the image of the passerby near the apparatus, and the passerby image extraction unit extracts the image of the passerby from the real-time circumstance image.

3. The apparatus of claim 2, wherein the circumstance image extraction unit is attached to the apparatus.

4. The apparatus of claim 1, wherein the trait information extraction unit extracts the trait information comprising at least one of gender information, age information, facial expression information, and belongings information regarding the passerby.

5. The apparatus of claim 4, wherein the trait information extraction unit comprises:
a preprocessor extracting an area of interest from the extracted image and aligning the area of interest;
a feature information extractor extracting feature information from the area of interest; and
a feature classifier comparing the feature information with reference information and extracting the trait information.

6. The apparatus of claim 5, wherein the predetermined reference information is created with reference to at least one of gender, age, facial expressions, and belongings and stored, and the feature classifier extracts at least one of gender information, age information, facial expression information, and belongings information regarding the passerby based on the predetermined reference information.

7. The apparatus of claim 5, wherein the preprocessor extracts the area of interest containing at least one of a facial area and a belongings area of the passerby.

8. The apparatus of claim 1, wherein the targeted advertisement obtainment unit selects the targeted advertisement from at least one kind of pre-stored advertising contents based on the trait information and a predetermined selection criterion.

9. The apparatus of claim 8, wherein the predetermined selection criterion comprises at least one of information regarding consumption patterns based on gender and information regarding advertising requirements of advertisers.

10. The apparatus of claim 1, wherein the targeted advertisement obtainment unit obtains the targeted advertisement containing an avatar created based on the trait information.

11. The apparatus of claim 10, wherein the targeted advertisement obtainment unit obtains the targeted advertisement by selecting advertising contents from at least one kind of pre-stored advertising contents based on the trait information and a pre-determined criterion and inserting the avatar into the selected advertising contents.

12. A method for providing an advertisement display device with targeted advertisements based on images of passersby, comprising:
extracting an image of a passerby;
extracting trait information regarding the passerby from the extracted image;
obtaining a targeted advertisement to be displayed based on the trait information; and
displaying the targeted advertisement.

13. The method of claim 12, wherein the method further comprises extracting a real-time circumstance image containing the image of the passerby near the advertisement display device before the extracting an image of a passerby, and
the extracting an image of a passerby comprises extracting the image of the passerby from the real-time circumstance image.

14. The method of claim 12, wherein the extracting of the trait information comprises extracting the trait information comprising at least one of gender information, age information, facial expression information, and belongings information regarding the passerby.

15. The method of claim 12, wherein the extracting of the trait information comprises:
extracting an area of interest from the extracted image and aligning the area of interest;
extracting feature information from the area of interest; and
comparing the feature information with the predetermined reference information and extracting the trait information.

16. The method of claim 15, wherein the predetermined reference information is created with reference to at least one of gender, age, facial expressions, and belongings and stored, and
the comparing the feature information with the predetermined reference information comprises extracting the trait information comprising at least one of gender information, age information, facial expression information, and belongings information regarding the passerby based on the predetermined reference information.

17. The method of claim 15, wherein the extracting of the area of interest comprises extracting the area of interest containing at least one of a facial area and a belongings area of the passerby.

18. The method of claim 12, wherein the obtaining of the targeted advertisement comprises selecting the targeted advertisement from at least one kind of pre-stored advertising contents based on the trait information and a predetermined selection criterion.

19. The method of claim 18, wherein the predetermined selection criterion comprises at least one of information regarding consumption patterns based on gender and information regarding advertising requirements of advertisers.

20. The method of claim 12, wherein the obtaining of the targeted advertisement comprises obtaining the targeted advertisement containing an avatar created based on the trait information.
